(19) United States
(12) Patent Application Publication
(10) Pub. No.: US 2017/0184279 A1
(43) Pub. Date: Jun. 29, 2017

(54) DIFFUSING REFLECTOR FOR LINEAR ARRAYS OF FINITE POINT LIGHT SOURCES

(71) Applicant: Anthony Italo Provitola, DeLand, FL (US)

(72) Inventor: Anthony Italo Provitola, DeLand, FL (US)

(21) Appl. No.: 14/980,398

(22) Filed: Dec. 28, 2015

(51) Int. Cl. F21V 7/00; F21K 99/00; G02B 5/02; F21V 23/02; F21V 7/04

(52) U.S. Cl. CPC F21V 7/0008; F21V 7/0066; F21V 23/02; F21V 7/043; G02B 5/0284; F21K 9/54; F21Y 2103/003

(57) ABSTRACT

The present invention is a reflector with a cylindrical shape which diffuses the finite point light sources in a linear array to present a substantially smooth bar of light to the viewer of the reflector.

### CROSS-REFERENCE TO RELATED APPLICATIONS

U.S. Design patent application Ser. No. 29/510,857 entitled REFLECTOR FOR HIDDEN STRIP LIGHT filed on Dec. 3, 2014 (Notice of Allowance mailed on Nov. 5, 2015); U.S. Design patent application Ser. No. 29/542,514 entitled REFLECTOR FOR HIDDEN STRIP LIGHT filed on Oct. 14, 2015 (Notice of Allowance mailed on Dec. 10, 2015).

### STATEMENT REGARDING FEDERALLY SPONSORED RESEARCH OR DEVELOPMENT

Not Applicable.

### REFERENCE TO MICROFICHE APPENDIX

Not Applicable

### BACKGROUND OF THE INVENTION

Although ultra bright light emitting diodes (LEDs) are a highly efficient light source, capable of emitting a very bright light with a very small amount of power, a direct view of an ultra bright LED is a point source which is too bright for the unprotected human eye to be exposed for a prolonged amount of time. Consequently the principal methods that are currently used for providing illumination with an ultra bright LED are with strong lens diffusion and broad reflection. However, diffusion has a significant cost of diminution of lighting efficiency of the LED, and broad reflection, such as for indirect lighting, does not provide sufficient brightness and portability for fixtures and lamps. The present invention advances the art of lighting to allow the use of ultra bright LEDs or any other strong finite point light source for fixtures and lamps without sacrificing efficiency by lens diffusion while permitting direct viewing of the fixture or lamp without exposure to the intense point source of light.

The prior art that this invention advances is generally the field of reflectors, lamps and light fixtures: Possible Classes/Subclasses: 119/483; 362/348; 362/224; 362/122; 211/43; 362/217.05; 362/217.07; 362/240; 362/263; 248/48.1; 356/138; 362/221; 362/219; 174/101; 248/441.1; 362/131; 362/217.06; 362/555; 362/222; 362/297; 362/244; 362/249.03; 40/603; 211/43; 40/745.

### BRIEF SUMMARY OF THE INVENTION

The present invention is a diffusing reflector for linear arrays of finite point light sources, such as strip circuits of light emitting diodes (LEDs), that enables a viewer to look directly at the entire reflector and see a fairly smooth bar of light without being directly exposed to the extremely bright points of light that characterize the LEDs in an array. This is achieved with a reflector which is the interior surface of a “hollow cylinder”, which is defined for this disclosure more generally than as a right cylinder with a circular cross-section.

### BRIEF DESCRIPTION OF THE DRAWINGS

FIG. 1 is a top front southwest isometric perspective view of a preferred embodiment of the diffusing reflector.

FIG. 2 is a top rear southwest isometric perspective view the preferred embodiment in FIG. 1 with the hollow cylinder shown as transparent to reveal the placement of a linear array of finite point light sources on the ledge of the reflector.

FIG. 3 is a front perspective view of a linear array of finite point light sources of the type shown in placement in FIG. 2.

FIG. 4 is a cross-section view of the diffusing reflector shown in FIG with a linear array of finite point light sources installed as shown in FIG. 2.

FIGS. 5-9 are cross-section views of examples of a preferred embodiment of the diffusion reflector shown without a linear array of finite point light sources installed.

### DETAILED DESCRIPTION OF THE INVENTION

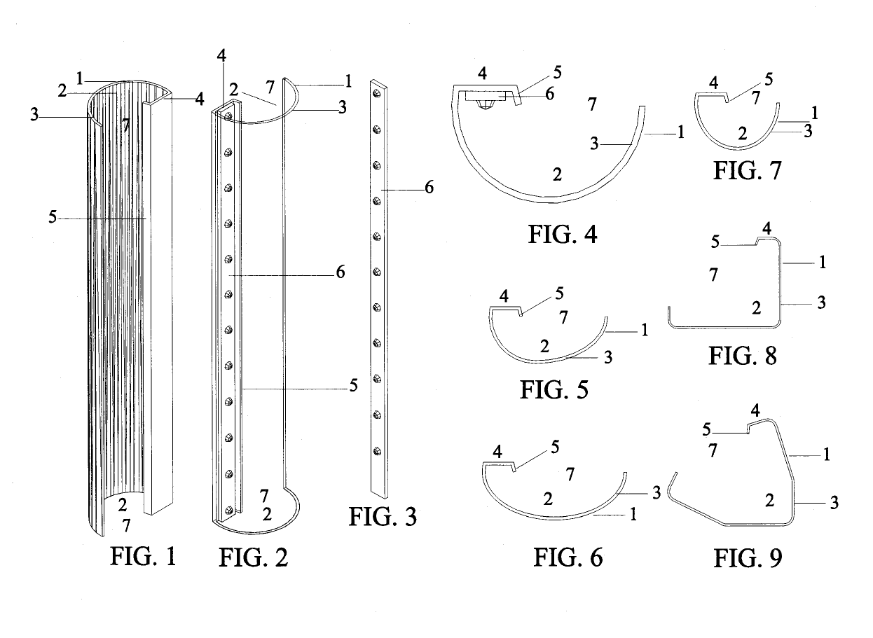

The present invention is a diffusing reflector without a lens or a mirror reflecting surface that reflects the light from a linear array of finite point light sources 6 (“light strip”), such as strip circuits of light emitting diodes (LEDs), and thereby converts the bright point light sources into a substantially smooth bar of light within and emanating from the cavity of the diffusing reflector 2, thus enabling a viewer to look directly at the entire reflector without being directly exposed to the extremely bright points of light that characterize the LEDs in an array. This is achieved with a “hollow cylinder” 1 as shown in FIG. 1 that has associated in its structure a ledge 4 upon which a light strip 6 can be mounted. The term “cylinder” is defined for this disclosure as a bar the exterior of which may have a cross-section of any shape, and which need not be uniform along its length. The term “hollow cylinder” shall be used in this disclosure in a broader sense to mean a “cylinder” as defined herein which has a hollow interior, also referred to herein as a “cavity” 2, which has an interior surface 3 within the hollow cylinder 1. However, the “hollow cylinder” so described is provided with an opening 7 along its length. This opening has associated in its structure a ledge 4 upon which a light strip 6 can be mounted so that the light from which can be directed into the cylindrical cavity 2 of the diffusing reflector at multiple angles. The ledge 4 also acts as a shield which hides the light strip 6 from a viewer of the diffusing reflector. The finite width beam from the ledge (not shown in the drawings) is directed into the cylindrical cavity 4 of the diffusing reflector at multiple angles. The light is reflected as diffused by the interior surface 3 of the hollow cylinder 1 after multiple reflections within the cylindrical cavity 2 and exits the opening 7 along the length of the reflector to appear as a substantially smooth bar of light.

The objects of the present invention are to provide:

1. for the use of bright point sources of light as a substantially uniform bar of light without the energy dissipation of a diffusion lens;

2. a reflector that does not expose the observer of the light therefrom to the bright points of the sources thereof;

3. a substantially uniform bar of light of various colors using bright point sources of light from a strip of LEDs.

These objects are realized by the shape of the reflecting interior surface 3 of the hollow cylinder with a texture of sufficient irregularity to randomize the images of the finite point light sources, so that the interior surface of the hollow cylinder 3 is not image-reflective, i.e. does not reflect an image of the finite point light sources such as with a mirror finish. The finish of the interior surface of the hollow cylinder wall may be satin, semi-gloss, or matte, depending how the finishes perform on the texture of the reflecting surface to achieve the stated purpose. The finish of the interior surface of the hollow cylinder may also be inherent in the material of which the cylinder wall is made, and the finish may also be provided to accurately reflect the various colors of light that may be generated by multicolor LEDs, such as a white finish would.

The shape which accomplishes this is the interior surface 3 of the hollow cylinder 1 with a curved (FIGS. 4-7) or polygonal (FIGS. 8 & 9) cross-section, concave continuously toward the interior of the hollow cylinder 1; plus the ledge 4 described above along the length of one edge of the opening 7, the ledge extending from the interior surface of one of the walls toward the opposite wall of the hollow cylinder 1. Thus the diffusing reflector appears in the cross-section of the whole thereof as a hollow cylinder 1 with an opening 7 along its length and a ledge 4 along one side of the opening 7 that extends from one of the walls of the hollow cylinder 1 toward the opposite wall of the hollow cylinder 1. The ledge 4 should be oriented with respect to the interior surface 3 of the hollow cylinder 1 to which it is attached so that it is within thirty (30) degrees of perpendicular to the interior surface 3 at the point of attachment.

The opening 7 along the length of the hollow cylinder 1 may have a uniform width along that length. The shape of the cross-section of the interior surface 3 of the hollow cylinder 1 may be uniform or may vary along the length of the hollow cylinder 1. The dimensions of the shape of the cross-section of the interior surface 3 of the hollow cylinder 1 may also be either uniform or vary along the length of the hollow cylinder 1.

Flexible LED light strips are usually flexible strip circuits that can bend lengthwise but not sideways. To accommodate a flat flexible LED light strip the ledge 4 must be flat in the same plane of the flatness of the LED light strip at the places in which they are in contact, and also slightly wider than the width of the LED light strip. The ledge 4 itself may have a shape along its length that can be followed by the flexibility of the LED light strip.

The embodiment shown in FIGS. 1 and 2 is one derived from a right regular cylinder with a uniform opening 7 from top to bottom. A right regular cylinder that has the same cross section from top to bottom and the top cross-section is directly above the bottom cross-section. To accommodate a flat flexible strip the ledge 4 along one side of the opening 7 of this embodiment must be flat sideways and lengthwise. In that case the ledge 4 along one side of the opening is straight for the length of the cylinder. However, many other embodiments can be imagined by varying the shape and size of the cross-section of the cylinder 1 along its length, varying the width of the opening 7 in the hollow cylinder 1 along its length, and utilizing the shape of an oblique cylinder. The shape of such other embodiments, however, challenge the usual geometric definition of the term cylinder, and, as previously stated, that term must be understood in this disclosure in a general and broader sense to accommodate the structure of those embodiments for which there is no specific geometric definition.

In a preferred embodiment the ledge 4 along one side of the opening has a lip 5 along the edge opposite to the side of attachment to the hollow cylinder 1 and extending toward the cavity 2 of the hollow cylinder 1. The lip 5 is not necessary for all embodiments, but for any embodiment in which it is employed, including the preferred embodiment, the lip 5 should be oriented so that it is within 45 degrees of perpendicular to the ledge 4.

As indicated at the outset of this detailed description a single reflector may serve as a simple light fixture. However, a light fixture may be comprised of many of these reflectors, arranged in various functional and decorative patterns and shapes.

While the invention has been disclosed in connection with the examples shown in the Figures, it will be understood that there is no intention to limit the invention to the particular embodiments shown, but it is intended to cover the general application of the various alternative and equivalent constructions included within the spirit and scope of this disclosure and the appended claims.

1. A diffusing light reflector and light fixture for a linear array of finite point light sources comprising:
(a) a hollow cylindrical body with
(1) an opening along its length that is at least as wide as the width of the linear array of finite point light sources, and
(2) an interior surface that is not image-reflective;
and
(b) a ledge along one side of the opening that extends from the interior surface of one of the walls of the hollow cylindrical body by said opening toward the opposite wall of the hollow cylinder; wherein a surface of said ledge that faces the interior of the hollow cylindrical body:
(1) is wide enough to accommodate the linear array of finite point light sources;
(2) is within thirty (30) degrees of perpendicular to the interior surface and extended from the wall of the cylindrical body;
(3) forms a cavity with the interior surface of the cylindrical body wherein light from the linear array of finite point light sources mounted on the ledge is diffused after multiple reflections within the cavity; and
(4) masks the finite point light sources from the view from outside of the hollow cylindrical body;
whereby the appearance of substantially smooth bar of light is formed by the light exiting the opening along the length of the reflector.

2. The diffusing light reflector and light fixture of claim 1, wherein the linear array of finite point light sources are light emitting diodes electrically connected on a strip circuit that powers the light sources.

3. The diffusing light reflector and light fixture of claim 1, wherein the width of the opening along the length of the hollow cylindrical body is uniform along the length of the hollow cylindrical body.

4. The diffusing light reflector and light fixture of claim 1, wherein an interior surface of the hollow cylindrical body is substantially concave toward the interior of the hollow cylindrical body.

5. The diffusing light reflector and light fixture of claim 1, wherein a cross-section of the interior surface of the hollow cylindrical body is uniform along the length of the hollow cylindrical body.

6. The diffusing light reflector and light fixture of claim 1, wherein the ledge along one side of the opening is substantially flat.

7. The diffusing light reflector and light fixture of claim 1, wherein the ledge along one side of the opening is substantially straight for the length of the cylindrical body.

8. The diffusing light reflector and light fixture of claim 1, wherein one side of the ledge along the opening has a lip opposite the side attached to the hollow cylindrical body, said lip extending toward the interior of the hollow cylindrical body.

9. The diffusing light reflector and light fixture of claim 8, wherein the lip along the ledge is within 45 degrees of perpendicular to the ledge.

10. The diffusing light reflector and light fixture of claim 1, wherein a texture of the interior surface of the hollow cylindrical body wall is of sufficient irregularity to randomize the reflection of light from the finite point light sources.

11. The diffusing light reflector and light fixture of claim 1, wherein the width of the ledge is uniform along the length of the cylindrical body.

12. The diffusing light reflector and light fixture of claim 1, wherein a finish of the interior surface of the hollow cylindrical body wall is satin, semi-gloss, or matte white.

13. A diffusing light reflector and light fixture for a linear array of finite point light sources comprising:
(a) a hollow cylindrical body with
(1) an opening along its length that is at least as wide as the width of the linear array of finite point light sources, and
(2) an interior surface that is substantially concave toward the interior of the hollow cylindrical body, and is not image-reflective;
and
(b) a ledge along one side of the opening that is attached to and extends from the interior surface of one of the walls of the hollow cylindrical body by said opening toward the opposite wall of the hollow cylinder; wherein a surface of said ledge that faces the interior of the hollow cylindrical body:
(1) is wide enough to accommodate the linear array of finite point light sources;
(2) is within thirty (30) degrees of perpendicular to the interior surface and extended from the wall of the cylindrical body;
(3) forms a cavity with the interior surface of the cylindrical body wherein light from the linear array of finite point light sources mounted on the ledge is diffused after multiple reflections within the cavity;
(4) masks the finite point light sources from the view from outside of the hollow cylindrical body; and
(5) has a lip along the edge opposite to the side of attachment to the hollow cylindrical body, said lip extending toward the interior of the hollow cylindrical body within 45 degrees of perpendicular to the ledge;
whereby the appearance of substantially smooth bar of light is formed by the light exiting the opening along the length of the reflector.

14. The diffusing light reflector and light fixture of claim 13, wherein the width of the opening along the length of the hollow cylindrical body is uniform along the length of the hollow cylindrical body.

15. The diffusing light reflector and light fixture of claim 13, wherein a finish of the interior surface of the hollow cylindrical body wall is satin, semi-gloss, or matte white.

16. The diffusing light reflector and light fixture of claim 13, wherein a texture of the interior surface of the hollow cylindrical body wall is of sufficient irregularity to randomize the reflection of light from the finite point light sources.

17. A diffusing light reflector and light fixture for a linear array of finite point light sources comprising:
(a) a hollow cylindrical body with
(1) an opening along its length that is at least as wide as the width of the linear array of finite point light sources;
(2) an interior surface that is substantially concave toward the interior of the hollow cylindrical body and-is not image-reflective;
and
(b) a ledge along one side of the opening that is attached to extends from the interior surface of one of the walls of the hollow cylindrical body by said opening toward the opposite wall of the hollow cylinder; wherein a surface of said ledge that faces the interior of the hollow cylindrical body:
(1) is wide enough to accommodate the linear array of finite point light sources;
(2) is within thirty (30) degrees of perpendicular to the interior surface and extended from the wall of the cylindrical body;
(3) forms a cavity with the interior surface of the cylindrical body wherein light from the linear array of finite point light sources mounted on the ledge is diffused after multiple reflections within the cavity;
(4) masks the finite point light sources from the view from outside of the hollow cylindrical body; and
(5) has a lip along the edge opposite to the side of attachment to the hollow cylindrical body, said lip extending toward the interior of the hollow cylindrical body;
whereby the appearance of substantially smooth bar of light is formed by the light exiting the opening along the length of the reflector.

18. The diffusing light reflector and light fixture of claim 17, wherein the linear array of finite point light sources are light emitting diodes electrically connected on a strip circuit that powers the light sources.

19. The diffusing light reflector and light fixture of claim 17, wherein a texture of the interior surface of the cylindrical body wall is of sufficient irregularity to randomize the reflection of light from the finite point light sources .

20. The diffusing light reflector and light fixture of claim 17, wherein the ledge along one side of the opening is substantially straight and flat.
